(19) United States
(12) Patent Application Publication
(10) Pub. No.: US 2003/0028869 A1
(43) Pub. Date: Feb. 6, 2003

(54) Method and computer program product for integrating non-redistributable software applications in a customer driven installable package

(76) Inventors: Daniel R. Drake, Apex, NC (US); John McGarvey, Apex, NC (US); Steven M. Miller, Apex, NC (US); Robert Leah, Cary, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 09/921,504

(22) Filed: Aug. 2, 2001

(51) Int. Cl. G06F 9/445

(52) U.S. Cl. 717/177

(57) ABSTRACT

An installation wizard is provided having panels that prompt a user to identify a location where a software prerequisite can be found prior to installing the TBI software. The wizard can optionally allow for the inclusion of files via a standard file browse dialog or via a URL. The prerequisite is then filly integrated into the install process so that, from the perspective of the installer, the installation proceeds seamlessly and without interruption.

### BACKGROUND OF THE INVENTION

1. Field of the Invention

The present invention relates to a computer system, and deals more particularly with a method, system, and computer program product for improving the installation of software applications that require installation of a software prerequisite.

2. Description of the Related Art

Use of computers in today's society has become pervasive. The software applications to be deployed, and the computing environments in which they will operate, range from very simple to extremely large and complex. Software applications are installed by novice or first-time users, who may simply want to install a game or similar application on a personal computer, as well as by experienced, highly-skilled system administrators with responsibility for large, complex computing environments. Although the complexity of the software and its installation may be different for a simple computing environment than for a more complex computing environment, it is has long been a goal of software developers to make the installation process as simple as possible.

Throughout this application, the following definitions are used:

“TBI application” means a software application to be installed;

“Software prerequisite” means a software file that must be installed for the TBI application to function properly or to perform a particular optional function;

“Installer” means the person installing a TBI application and/or a software prerequisite. An installer may be an end-user of the TBI application or a system administrator responsible for running large computer systems and networks;

“Wizard” means a tool, typically embodied as a “pop-up” within a Graphical User Interface (GUI), which provides step-by-step instructions and prompts to assist a user of the GUI in performing certain functions, e.g., installation of a TBI application.

“Target Machine” means a computer, processor, PDA or other processing device on which software applications are installed and processed.

The software installation process has become simplified as the use of computers has increased. Advances in this area have been made in recent years, such that today, many TBI software packages use some type of automated, self-installing procedure. For example, a file (which, by convention, is typically named “setup.exe” or “install.exe”) is often provided on an installation medium (such as a diskette or CD-ROM). When the installer issues a command to execute this file, an installation program begins. Issuance of the command may even be automated in some cases, whereby simply inserting the installation medium into a mechanism such as a CD-ROM reader automatically launches the installation program and the appropriate wizard.

These automated techniques are quite beneficial in enabling the installer to get started with an installation. However, there are a number of other factors that may result in a complex installation process, especially for large-scale TBI applications that are to be deployed in enterprise computing environments. One example is in the area of software prerequisites that must be accounted for in the installation process.

Many TBI software applications require software prerequisites to be installed prior to their installation. Often these software prerequisites are packaged with the TBI software because the software prerequisite is owned or licensed by the TBI software vendor. Software prerequisites that can be distributed with the TBI software application by the TBI software-application vendor are referred to herein as “licensed prerequisites.” TBI software applications with licensed prerequisites do not present a significant problem. The installation program associated with the TBI software application may be automatically directed to the prerequisite software file at the appropriate time during installation and it is installed, right from the installation medium. Alternatively, the installer will be notified that a prerequisite is required, the installation will be aborted while the installer installs the prerequisite (typically provided with the TBI application on the same medium, e.g., on the same CD), and then the installer will resume the installation.

However, in many cases, software installations have prerequisite applications which are not legally redistributable by the TBI software vendor. For example, in the Windows NT environment, many software applications require a specific level of “service pack” that must be installed by the user prior to running the TBI software vendor's installation program. These service packs are typically not licensed for distribution with the TBI software application; such prerequisites are referred to herein as “unlicensed prerequisites.” Since the unlicensed prerequisite cannot be shipped with the TBI software application, during the software installation a user is typically alerted as to the necessity for the unlicensed prerequisite. Typically, the installer will be directed to cancel the installation process, load the unlicensed prerequisite (e.g., from a website or from a separate storage medium) and then, once the unlicensed prerequisite is installed, reinitiate the installation procedure.

While this method functions adequately, it is an unnecessary time-wasting activity in an era where even minutes of time are at a premium. Further, in the case of a system administrator who must install the software on hundreds of computers of a system, the wasting of time involved in separately installing the unlicensed prerequisites is unacceptable.

Accordingly, what is needed is an improved technique for installation of software packages which allows the inclusion, distribution, and integration of unlicensed prerequisites into a TBI software application's installation program, thereby enabling the installation process to be simplified for software installers who must install software in an efficient, trouble-free manner.

### SUMMARY OF THE INVENTION

An object of the present invention is to provide an improved technique for installation of software packages. In accordance with the present invention, an installation wizard is provided having panels that prompt a user to identify a location where a software prerequisite can be found prior to installing the TBI software. The wizard can optionally allow for the inclusion of files via a standard file browse dialog or via a URL. The prerequisite is then fully integrated into the install process so that, from the perspective of the installer, the installation proceeds seamlessly and without interruption.

Other objects and advantages of the present invention will be set forth in part in the description and in the drawings which follow and, in part, will be obvious from the description or may be learned by practice of the invention.

The present invention will now be described with reference to the following drawings, in which like reference numbers denote the same element throughout.

### BRIEF DESCRIPTION OF THE DRAWINGS

FIG. 1 is a flowchart illustrating an example of steps performed in accordance with the present invention;

FIG. 2 is an illustration of an example of a prerequisite selection panel in accordance with the present invention;

FIG. 3 is a block diagram of a computer workstation environment in which the present invention may be practiced; and

FIG. 4 is a diagram of a networked computing environment in which the present invention may be practiced.

### DETAILED DESCRIPTION OF THE PREFERRED EMBODIMENTS

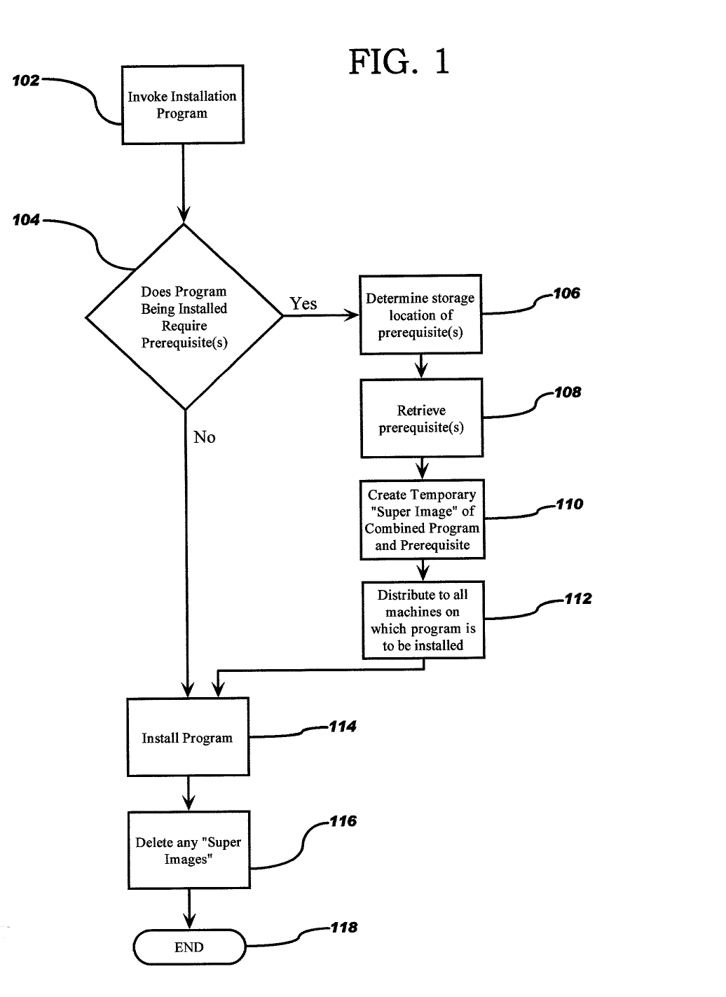

FIG. 1 is a flowchart illustrating the steps performed in accordance with the present invention. Referring to FIG. 1, at step 102 the installation program of the present invention is invoked. Typically, this will involve the launching of an installation wizard to prompt the installer through the installation process. At step 104, a determination is made as to whether or not the TBI software being installed requires any software prerequisites.

If the TBI software does not require software prerequisites, the process proceeds to step 114 where the TBI software is installed. However, if at step 104 a determination is made that software prerequisites are required, then at step 106 the location of the software prerequisites are determined. In a preferred embodiment, the installer will be prompted to insert a path/filename or a web address where the software prerequisite can be found; alternatively, the installer can utilize a standard “browse” function to browse to the location of the software prerequisite.

At step 110, a temporary “super image” of the combined TBI software and software prerequisites is created. This super image is essentially an “installation version” of the TBI software. The TBI software and the software prerequisites, which, when combined form the “super image”, can be wrapped together using known techniques in which both programs are stored in a single “container” in a well known manner. In the preferred embodiment, the super image is created using object modeling as described in commonly-assigned co-pending patent application No. 09/669,227, entitled “Object Model and Framework for Installation of Software Packages Using JavaBeans™”, filed on Sep. 25, 2000.

Once the temporary super image is created, the super image is then distributed to all machines on which the TBI software is to be installed (step 112). Then, at step 114, the TBI software is installed, already having the software prerequisites available as part of the installation process (step 114). Once the TBI software has been fully installed, at step 116, the “super images” are deleted and the process is complete.

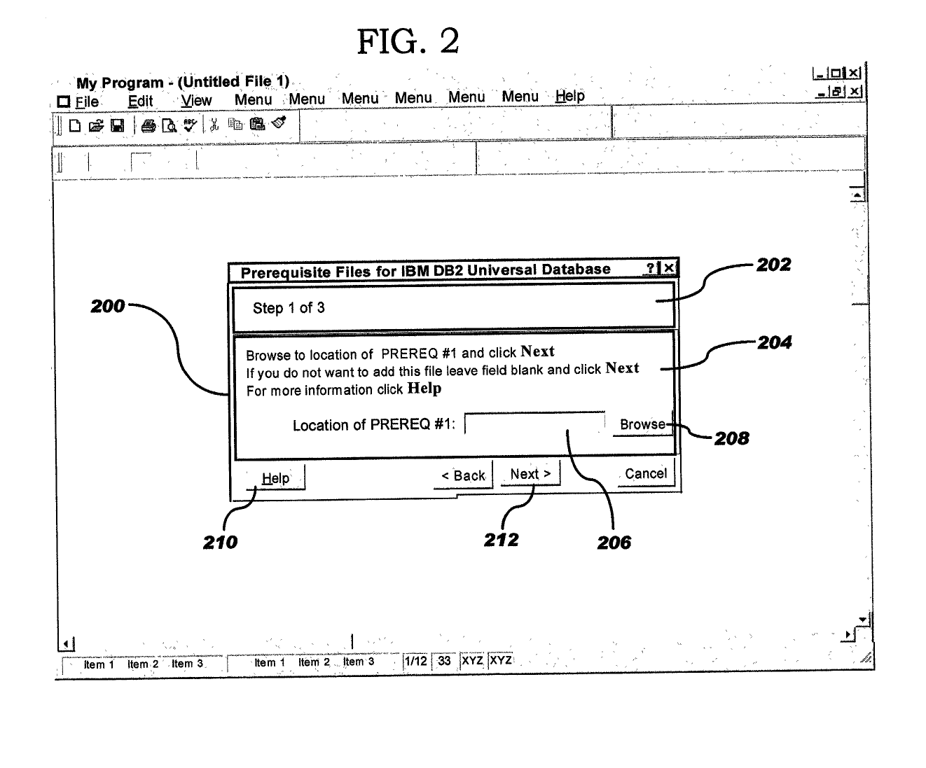

FIG. 2 illustrates an example of a software prerequisite selection panel which can be included in an installation wizard in accordance with the present invention. As shown in FIG. 2, a panel 200 includes a first subpanel 202 and a second subpanel 204. Subpanel 202 provides, among other things, an indication of the number of prerequisites that are required for the particular TBI software being loaded. For example, in the panel illustrated in FIG. 2, the text “step 1 of 3” indicates that the TBI software, IBM DB2 Universal Database, will require three prerequisite files in connection with the loading process.

Subpanel 204 includes a text area which provides the installer with information regarding software prerequisites to be installed, and prompts identifying steps that may be taken by the installer. Subpanel 204 also includes a selection entry window 206 and a browse button 208.

Using selection entry window 206, if the user knows the path/file name or URL of the location where the prerequisite file can be obtained (e.g., called “PREREQ #1” in this example), then the location can be manually input into selection entry window 206. This will cause the installation program to go to the location identified prior to installing the main program, thereby obtaining the appropriate prerequisite. Alternatively, if the location is not known specifically, browse button 208 can be utilized in a well known manner to look through existing files to find and select the appropriate file location.

Help button 210 is provided so that, if the installer does not know the location of the software prerequisite, hints may be given by depressing Help button 210.

Once the location information for the software prerequisite file has been input or selected, the installer presses the next button to either move to the next prerequisite location panel or continue with the installation, if there are no additional installation files to be obtained.

Using this invention, an installer can seamlessly integrate an unlicensed or licensed software prerequisite within the software installation process. If desired, default values for the URL can be automatically inserted in the wizard panel to make the selection process easier. Further, as noted above, information regarding alternative locations for the software prerequisites can be included in the Help panel accessible from the prerequisite selection panel. Using the present invention, the prerequisite is fully integrated into the install process.

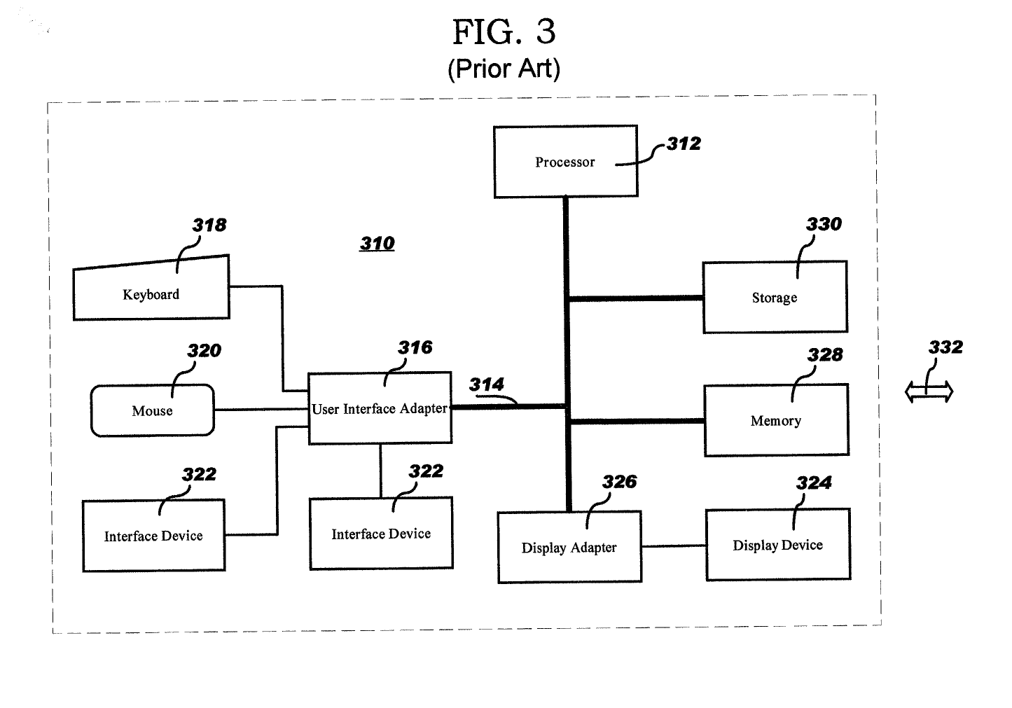

FIG. 3 illustrates a representative workstation hardware environment in which the present invention may be practiced. The environment of FIG. 3 comprises a representative single user computer workstation 310, such as a personal computer, including related peripheral devices. The workstation 310 includes a microprocessor 312 and a bus 14 employed to connect and enable communication between the microprocessor 312 and the components of the workstation 310 in accordance with known techniques. The workstation 310 typically includes a user interface adapter 316, which connects the microprocessor 312 via the bus 314 to one or more interface devices, such as a keyboard 318, mouse 320, and/or other interface devices 322, which can be any user interface device, such as a touch sensitive screen, digitized entry pad, etc. The bus 314 also connects a display device 324, such as an LCD screen or monitor, to the microprocessor 312 via a display adapter 326. The bus 314 also connects the microprocessor 312 to memory 328 and long-term storage 330 which can include a hard drive, diskette drive, tape drive, etc.

The workstation 310 may communicate with other computers or networks of computers, for example via a communications channel or modem 332. Alternatively, the workstation 310 may communicate using a wireless interface at 332, such as a CDPD (cellular digital packet data) card. The workstation 310 may be associated with such other computers in a LAN or a wide area network (WAN), or the workstation 310 can be a client in a client/server arrangement with another computer, etc. All of these configurations, as well as the appropriate communications hardware and software, are known in the art.

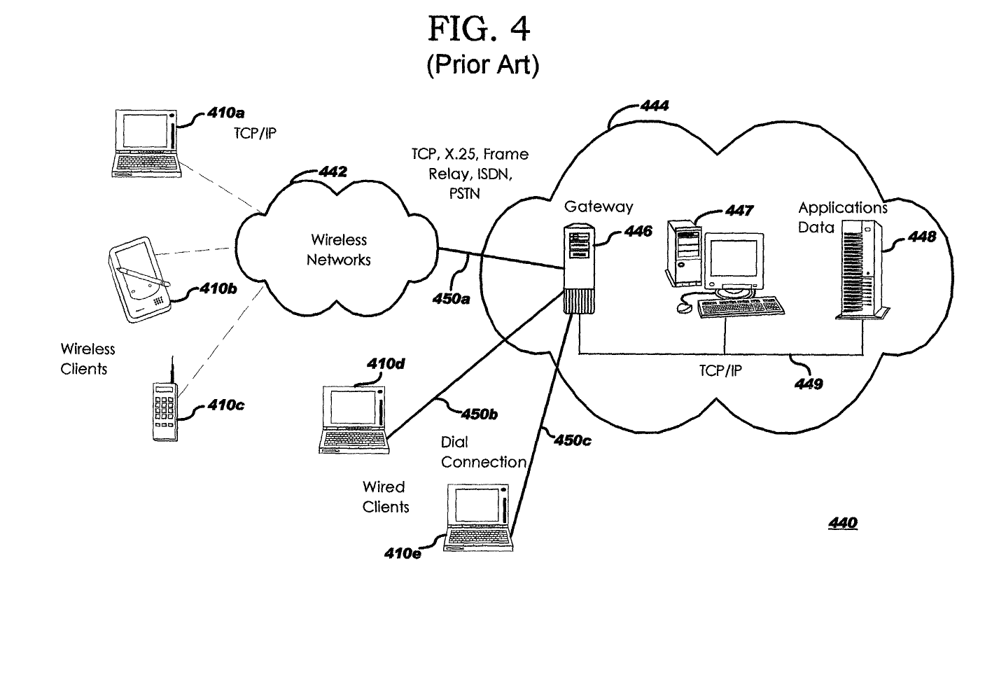

FIG. 4 illustrates a data processing network 440 in which the present invention may be practiced. The data processing network 440 may include a plurality of individual networks, such as wireless network 442 with associated wireless workstations 410a (a laptop connected via wireless modem), 410b (a PDA connected via wireless modem) and 410c (a cellular telephone), and network 444 with associated wired workstations 410d and 410e. Additionally, as those skilled in the art will appreciate, one or more LANs may be included (not shown), where a LAN may comprise a plurality of intelligent workstations coupled to a host processor.

Still referring to FIG. 4, the networks 442 and 444 may also include mainframe computers or servers, such as a gateway computer 446 or application server 447 (which may access a data repository 448). A gateway computer 446 serves as a point of entry into each network 444. The gateway computer 446 may be preferably coupled to another network 442 by means of a communications link 450a. The gateway computer 446 may also be directly coupled to one or more workstations using a communications link 450b, 450c. The gateway computer 446 may be implemented utilizing an Enterprise Systems Architecture/370™ available from the International Business Machines Corporation (IBM), an Enterprise Systems Architecture/390® computer, etc. Depending on the application, a midrange computer, such as an Application System/400® (also known as an AS/400®) may be employed. (“Enterprise Systems Architecture/370” is a trademark of IBM; “Enterprise Systems Architecture/390”, “Application System/400”, and “AS/400” are registered trademarks of IBM.)

The gateway computer 446 may also be coupled 449 to a storage device (such as data repository 448). Further, the gateway 446 may be directly or indirectly coupled to one or more workstations.

Those skilled in the art will appreciate that the gateway computer 446 may be located a great geographic distance from the network 442, and similarly, the workstations 410a-410e may be located a substantial distance from the networks 442 and 444. For example, the network 442 may be located in California, while the gateway computer 446 may be located in Texas, and one or more of the workstations 410a-410e may be located in New York. The workstations 410a-410c may connect to the wireless network 442 using a networking protocol such as the Transmission Control Protocol/Internet Protocol (“TCP/IP”) over a number of alternative connection media, such as cellular phone, radio frequency networks, satellite networks, etc. The wireless network 442 preferably connects to the gateway computer 446 using a network connection 450a such as TCP or UDP (User Datagram Protocol) over IP, X.25, Frame Relay, ISDN (Integrated Services Digital Network), PSTN (Public Switched Telephone Network), etc. The workstations 410d-410e may alternatively connect directly to the gateway computer 446 using dial connections 450b or 450c. Further, the wireless network 442 and network 444 may connect to one or more other networks (not shown), in an analogous manner to that depicted in FIG. 4.

Software programming code which embodies the present invention is typically accessed by the microprocessor 412 (e.g. of workstations 410a-e and/or server 447) from long-term storage media 430 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 428, and accessed by the microprocessor 412 using the bus 414. The techniques and methods for embodying software programming code in memory, on physical media, and/or distributing software code via networks are well known and will not be further discussed herein.

A user of the present invention (e.g. a software installer) may connect his computer to a server using a wireline connection, or a wireless connection. (Alternatively, the present invention may be used in a stand-alone mode without having a network connection.) Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing capabilities (and communication capabilities, when the device is network-connected). The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

In the preferred embodiment, the present invention is implemented as one or more computer software programs. The software is preferably implemented using an object-oriented programming language such as the Java™ programming language. The model which is used for describing the aspects of software installation packages is preferably designed using object-oriented modeling techniques of an object-oriented paradigm. In the preferred embodiment, the objects which are based on this model, and which are created to describe the installation aspects of a particular installation package, are preferably defined using JavaBeans™ (or objects having similar characteristics). (“Java” and “JavaBeans” are trademarks of Sun Microsystems, Inc.)

An implementation of the present invention may be executing in a Web environment, where software installation packages are downloaded using a protocol such as the HyperText Transfer Protocol (HTTP) from a Web server to one or more target computers which are connected through the Internet. Alternatively, an implementation of the present invention may be executing in other non-Web networking environments (using the Internet, a corporate intranet or extranet, or any other network) where software packages are distributed for installation using techniques such as Remote Method Invocation (RMI) or CORBA (Common Object Request Broker Architecture). Configurations for the environment include a client/server network, as well as a multi-tier environment. Or, as stated above, the present invention may be used in a stand-alone environment, such as by an installer who wishes to install a software package from a locally-available installation media rather than across a network connection. A software developer who prepares a software package for installation using the present invention may use a network-connected workstation, a stand-alone workstation, or any other similar computing device. These environments and configurations are well known in the art.

The target devices with which the present invention may be used advantageously include end-user workstations, mainframes or servers on which software is to be loaded, or any other type of device having computing or processing capabilities (including “smart” appliances in the home, cellular phones, PDAs, dashboard devices, etc.).

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of integrating the installation, on one or more target machines, of software prerequisites with a to-be-installed (TBI) software application, comprising the steps of:
determining if said TBI software application requires any software prerequisites;
obtaining all required software prerequisites;
creating a super image comprising the TBI software application wrapped with said software prerequisites; and
distributing said super image to all machines on which said software application is to be installed.

2. A method as set forth in claim 1, wherein said step of creating a super image comprise s at least the steps of:
defining an object model representing the integrated software installation; and
populating the object model with attributes and methods to describe the TBI software application and said required software prerequisites.

3. A method as set forth in claim 2, wherein said step of creating a super image further comprises at least the step of instantiating one or more objects according to the defined object model, and wherein the populating step populates the instantiated object(s).

4. A method as set forth in claim 3, wherein the instantiating step instantiates an object for the the TBI software application and one or more component objects for each of said prerequisites.

5. A method as set forth in claim 4, further comprising the step of using the populated object model to install the TBI software application.

6. A method as set forth in claim 5, wherein the step of using the populated object model further comprises at least the steps of:
identifying one or more target machines on which the TBI software application is to be installed;
downloading the super image to the identified target machines; and
performing an installation at each of the identified target machines using the downloaded super image.

7. A method as set forth in claim 1, wherein said super image is a temporary file that is deleted from said target machines upon completion of the installation process.

8. A method for improving installation of software packages on one or more target machines, comprising the steps of:
identifying, prior to installation, software prerequisites that need to be installed with a particular software package;
obtaining said identified software prerequisites;
creating a super image comprising said software package and said identified software prerequisites; and
distributing said super image to all target machines.

9. A method as set forth in claim 8, wherein said step of creating a super image comprises at least the steps of:
defining an object model representing the software installation being performed; and
populating the object model with attributes and methods to describe the particular software package and any required software prerequisites identified.

10. A method as set forth in claim 9, wherein said step of creating a super image further comprises at least the step of instantiating one or more objects according to the defined object model, and wherein the populating step populates the instantiated object(s).

11. A method as set forth in claim 10, wherein the instantiating step instantiates an object for the particular software package and one or more component objects for each of said identified software prerequisites.

12. The method of claim 11, further comprising the step of using the populated object model to install the particular software package.

13. The method of claim 12, wherein the step of using the populated object model further comprises at least the steps of:
identifying one or more target machines on which the particular software package is to be installed;
downloading the super image to the identified target machines; and
performing an installation at each of the identified target machines using the downloaded super image.

14. A method as set forth in claim 8, wherein said super image is a temporary file that is deleted from said target machines upon completion of the installation process.

15. A system of integrating the installation, on one or more target machines, of software prerequisites with a to-be-installed (TBI) software application, comprising:
means for determining if said TBI software application requires any software prerequisites;
means for obtaining all required software prerequisites;
means for creating a super image comprising the TBI software application wrapped with said software prerequisites; and
means for distributing said super image to all machines on which said software application is to be installed.

16. A system as set forth in claim 15, wherein said means for creating a super image comprises at least:
means for defining an object model representing the integrated software installation; and
means for populating the object model with attributes and methods to describe the TBI software application and said required software prerequisites.

17. A system as set forth in claim 16, wherein said means for creating a super image further comprises at least means for instantiating one or more objects according to the defined object model, and wherein the populating step populates the instantiated object(s).

18. A system as set forth in claim 17, wherein said means for instantiating instantiates an object for the the TBI software application and one or more component objects for each of said prerequisites.

19. A system as set forth in claim 18, further comprising means for using the populated object model to install the TBI software application.

20. A system as set forth in claim 19, wherein said means for using the populated object model further comprises at least:
means for identifying one or more target machines on which the TBI software application is to be installed;
means for downloading the super image to the identified target machines; and
means for performing an installation at each of the identified target machines using the downloaded super image.

21. A system as set forth in claim 15, wherein said super image is a temporary file that is deleted from said target machines upon completion of the installation process.

22. A computer program product embodied on computer-readable medium for integrating the installation, on one or more target machines, of software prerequisites with a to-be-installed (TBI) software application, the computer program product comprising executable instructions for:
determining if said TBI software application requires any software prerequisites;
obtaining all required software prerequisites;
creating a super image comprising the TBI software application wrapped with said software prerequisites; and
distributing said super image to all machines on which said software application is to be installed.

23. A computer program product as set forth in claim 22, wherein said computer executable instructions for creating a super image include computer executable instructions for:
defining an object model representing the integrated software installation; and
populating the object model with attributes and methods to describe the TBI software application and said required software prerequisites.

24. A computer program product as set forth in claim 23, wherein said computer executable instructions for a super image further includes computer executable instructions for: instantiating one or more objects according to the defined object model, and wherein the computer executable instructions for populating the object model populates the instantiated object(s).

25. A computer program product as set forth in claim 24, wherein computer executable instructions for instantiating instantiates an object for the the TBI software application and one or more component objects for each of said prerequisites.

26. A computer program product as set forth in claim 25, further comprising computer executable instructions for using the populated object model to install the TBI software application.

27. A computer program product as set forth in claim 25, wherein computer executable instructions for using the populated object model further includes computer executable instructions for:
identifying one or more target machines on which the TBI software application is to be installed;
downloading the super image to the identified target machines; and
performing an installation at each of the identified target machines using the downloaded super image.

28. A computer program product as set forth in claim 22, wherein said super image is a temporary file that is deleted from said target machines upon completion of the installation process.
